(19) United States
(12) Patent Application Publication
(10) Pub. No.: US 2020/0160803 A1
(43) Pub. Date: May 21, 2020

(54) LIQUID CRYSTAL DISPLAY DEVICE

(71) Applicant: SHARP KABUSHIKI KAISHA, Sakai City, Osaka (JP)

(72) Inventor: MASAKATSU TOMINAGA, Sakai City, Osaka (JP)

(21) Appl. No.: 16/617,483

(22) PCT Filed: May 29, 2018
(86) PCT No.: PCT/JP2018/020442

§ 371 Date: Nov. 26, 2019

(30) Foreign Application Priority Data
May 30, 2017 (JP) 2017-106079

(51) Int. Cl. G09G 3/36

(52) U.S. Cl. CPC G09G 3/3614; G09G 2320/0247; G09G 3/3607; G09G 3/3648

(57) ABSTRACT

Provided is a liquid crystal display device in which it is unlikely that flicker would occur, even if a polarity of a data voltage is inverted at every frame, in a case where a single color is displayed. The liquid crystal display device includes, on an active matrix substrate, a plurality of subpixels; a plurality of source lines SLn to SLn+3 to each of which a data voltage having either a positive polarity or a negative polarity is applied; and a plurality of gate lines GLn−3 to GLn+3 connected with pixel electrodes 16 in the subpixels. The liquid crystal display device includes a plurality of color filters of different colors on a counter substrate. Each of the subpixels corresponds to any one of colors (R, G, B), and each pixel PIX is composed of the subpixels of the plurality of colors. Each of the subpixels included in the each pixel is connected with the source line to which a data voltage having a polarity opposite to a polarity of a data voltage applied to the subpixel included in another pixel adjacent to the said pixel in a gate line extending direction or a source line extending direction is applied, the subpixel included in the another pixel being of the same color as the color of the said subpixel.

### TECHNICAL FIELD

The present invention relates to a liquid crystal display device.

### BACKGROUND ART

Conventionally, a technique of periodically inverting polarities of voltages to be applied to pixels in order to prevent the deterioration of liquid crystal in a liquid crystal display device has been proposed. Such a liquid crystal display device is disclosed in JP-A-2007-188089. This liquid crystal display device includes a display panel in which pixels corresponding to colors of red (R), green (G), and blue (B) (hereinafter referred to as pixels R, pixels G, and pixels B, respectively) are arranged in matrix. In the display panel, three gate lines that are a first gate line, a second gate line, and a third gate line are provided with respect to every two pixel rows. The second gate line is arranged between the first gate line and the third gate line. Pixel electrodes of the pixels R and the pixels B in one of the two pixel rows are connected with the first gate lines. Pixel electrodes of the pixels R and the pixels B in the other one of the two pixel rows are connected with the third gate lines. Pixel electrodes of the pixels G in the two pixel rows are connected with the second gate lines.

Further, in the display panel, two data lines are provided with respect to every three pixel columns, and data voltages of polarities opposite to each other are applied to these two data lines, respectively. The pixels R are connected with data lines to which positive-polarity data voltages are applied, and the pixels B are connected with data lines to which negative-polarity data voltages are applied. Further, the pixels G in one of the two pixel rows are connected to data lines to which negative-polarity data voltages are applied, and the pixels G in the other one of the pixel rows are connected with data lines to which positive-polarity data voltages are applied.

### SUMMARY OF THE INVENTION

In the configuration disclosed in JP-A-2007-188089, for example, in a case where the polarity of a data voltage applied to each data line is inverted at every frame and only red color or blue color is displayed, the polarities of the data voltages applied to the pixels R or the pixels B are unbalanced to either the positive polarity or the negative polarity. Accordingly, when the polarity of the data voltage is inverted at every frame, the voltage polarity of the pixel is inverted at every screen, resulting in that flicker occurs.

It is an object of the present invention to provide a liquid crystal display device in which it is unlikely that flicker would occur, even if the polarity of the data voltage is inverted at every frame, in a case where a single color is displayed.

In order to achieve the above-described object, a liquid crystal display device of the invention of the present application includes: an active matrix substrate; a counter substrate that is arranged so as to be opposed to the active matrix substrate; and a liquid crystal layer interposed between the active matrix substrate and the counter substrate, wherein the active matrix substrate includes: a plurality of subpixels arranged in matrix; a plurality of source lines to each of which a data voltage having either a positive polarity or a negative polarity with respect to a predetermined potential as a reference is applied; and a plurality of gate lines connected with the subpixels, the counter substrate includes color filters that have a plurality of different colors, each of the subpixels corresponds to any one of the colors, and each pixel is composed of the subpixels of the plurality of colors, and each of the subpixels included in the each pixel is connected to the source line to which a data voltage having a polarity opposite to a polarity of a data voltage applied to the subpixel included in another pixel adjacent to the said pixel in a gate line extending direction or a source line extending direction is applied, the subpixel included in the another pixel being of the same color as the color of the said subpixel.

With the configuration of the present invention, it is unlikely that flicker would occur, even if the polarity of the data voltage is inverted at every frame, in a case where a single color is displayed.

### BRIEF DESCRIPTION OF DRAWINGS

FIG. 1 shows a schematic configuration of a liquid crystal display device according to Embodiment 1.

FIG. 2 is a top view showing a schematic configuration of the active matrix substrate shown in FIG. 1.

FIG. 3 is a top view showing a schematic configuration of a display area shown in FIG. 2.

FIG. 4 schematically shows a part extracted from the display area shown in FIG. 3.

FIG. 5 schematically shows exemplary polarities of data voltage signals input to source lines SL shown in FIG. 4, and exemplary polarities of respective voltages of the subpixels, in a certain frame.

FIG. 6 shows polarities of pixel voltages in a case where only red color is displayed.

FIG. 7 schematically shows an exemplary arrangement of subpixels in Embodiment 2.

FIG. 8 shows polarities of pixel voltages in a case where only red color is displayed with the subpixels shown in FIG. 7.

FIG. 9 schematically shows an exemplary arrangement of subpixels in Embodiment 3.

FIG. 10 shows polarities of pixel voltages in a case where only red color is displayed with the subpixels shown in FIG. 9.

### MODE FOR CARRYING OUT THE INVENTION

The first configuration of the liquid crystal display device according to the present invention includes: an active matrix substrate; a counter substrate that is arranged so as to be opposed to the active matrix substrate; and a liquid crystal layer interposed between the active matrix substrate and the counter substrate, wherein the active matrix substrate includes: a plurality of subpixels arranged in matrix; a plurality of source lines to each of which a data voltage having either a positive polarity or a negative polarity with respect to a predetermined potential as a reference is applied; and a plurality of gate lines connected with the subpixels, the counter substrate includes color filters that have a plurality of different colors, each of the subpixels corresponds to any one of the colors, and each pixel is composed of the subpixels of the plurality of colors, and each of the subpixels included in the each pixel is connected to the source line to which a data voltage having a polarity opposite to a polarity of a data voltage applied to the subpixel included in another pixel adjacent to the said pixel in a gate line extending direction or a source line extending direction is applied, the subpixel included in the another pixel being of the same color as the color of the said subpixel.

According to the first configuration, data voltages having polarities opposite to each other are applied to the subpixels of the same color in the pixels adjacent in the gate line extending direction or the source line extending direction. Therefore, even if the polarities of the data voltages of the source lines are inverted at every frame and only red color is displayed, the polarities of the pixel voltages polarities of the subpixels are not biased to either one of the polarities, which makes it unlikely that flicker would occur.

In the first configuration, in the pixels adjacent in the source line extending direction, among the subpixels of the plurality of colors, the subpixels of one of the colors are located at the same positions in the gate line extending direction, and the subpixels of each of the other colors are located at positions different from each other in the gate line extending direction (the second configuration).

The first configuration may be further characterized in that, in the pixels adjacent in the source line extending direction, the subpixels of the plurality of colors may be arranged in such a manner that the subpixels of the same color are located at different positions in the gate line extending direction (the third configuration).

The first configuration may be further characterized in that the plurality of colors include at least three colors; and position relationship of the subpixels of the colors other than one color, among the subpixels of the plurality of colors in one of the pixels, is different from position relationship of the subpixels of the colors other than the one color, in another one of the pixels that is adjacent to the said pixel in the gate line extending direction (the fourth configuration).

Any one of the first to fourth configurations may be further characterized in that the plurality of colors include three colors that are different from one another the source lines are arranged in such a manner that two of the source lines to which data voltages having polarities opposite to each other are applied, respectively, are provided with respect to every three columns of the subpixels; the polarities of the data voltages applied to the source lines are inverted at every frame; and the gate lines are arranged approximately in parallel in such a manner that three of the gate lines are provided with respect to two rows of the subpixels (the fifth configuration).

According to the fifth configuration, the number of the gate lines increases as compared with a case where one gate line is provided with respect to every one subpixel; however, as compared with a case where one source line is provided with respect to every subpixel, the number of the source lines can be reduced.

Any one of the first to fifth configurations may be further characterized in that the active matrix substrate further includes: a common electrode; and a plurality of common electrode lines that are provided approximately in parallel with the source lines and are connected with the common electrode (the sixth configuration).

With the sixth configuration, it is possible to cause the common electrode to have a lower resistance.

The following description describes embodiments of the present invention in detail, while referring to the drawings. Identical or equivalent parts in the drawings are denoted by the same reference numerals, and the descriptions of the same are not repeated.

### Embodiment 1

### (Configuration of Liquid Crystal Display Device)

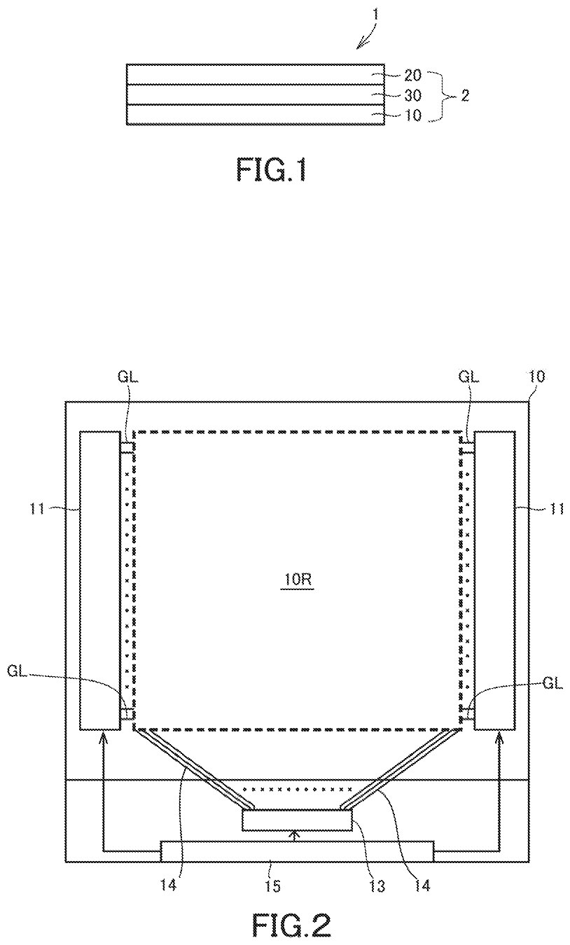

FIG. 1 schematically shows a schematic configuration of a liquid crystal display device according to the present embodiment. As shown in FIG. 1, a liquid crystal display device 1 includes, as a display panel 2, an active matrix substrate 10, a counter substrate 20, and a liquid crystal layer 30 interposed between the active matrix substrate 10 and the counter substrate 20.

Though the illustration is omitted in FIG. 1, a pair of polarizing plates are provided on a lower surface of the active matrix substrate 10 and a top surface of the counter substrate 20, respectively. Further, color filters (not shown) of three colors of red (R), green (G), and blue (B) are formed on the counter substrate 20.

FIG. 2 schematically shows a schematic configuration of the active matrix substrate 10. As shown in FIG. 2, the active matrix substrate 10 has a display area 10R, and includes gate drivers 11, a source driver 13, lines 14, and a terminal part 15 outside the display area 10R.

Each of the gate drivers 11 and the source driver 13 is electrically connected with the terminal part 15. The lines 14 are electrically connected with the source drivers 13. To the terminal part 15, timing signals, control signal, and the like for driving the gate drivers 11 and the source driver 13 are input from a display control circuit that is not shown.

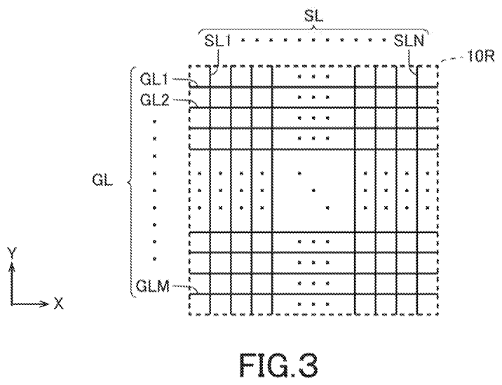

FIG. 3 schematically shows a schematic configuration of the display area 10R. As shown in FIG. 3, in the display area 10R, there are provided a plurality of gate lines GL (GL1 to GLM), and a plurality of source lines SL (SL1 to SLN) that intersect with the gate lines GL.

Each gate line GL is connected to with the gate driver 11 (FIG. 2). In this example, the gate drivers 11 are provided at the ends on both sides of the gate line GL. The gate line GL is switched to the selected state by simultaneously driving the two gate drivers 11 provided at ends on both sides of the gate line GL.

The source lines SL are electrically connected with the source driver 13 (FIG. 3) via the lines 14 (FIG. 3), which are connected to the source driver 13. To the source lines SL, data voltage signals are input from the source driver 13.

In this example, the data voltage signal has either a positive polarity or a negative polarity with respect to a potential of common electrodes (not shown) provided on the counter substrate 20 as a reference potential. The source driver 13 inverts the polarity of the data voltage signal to the source line SL at every frame.

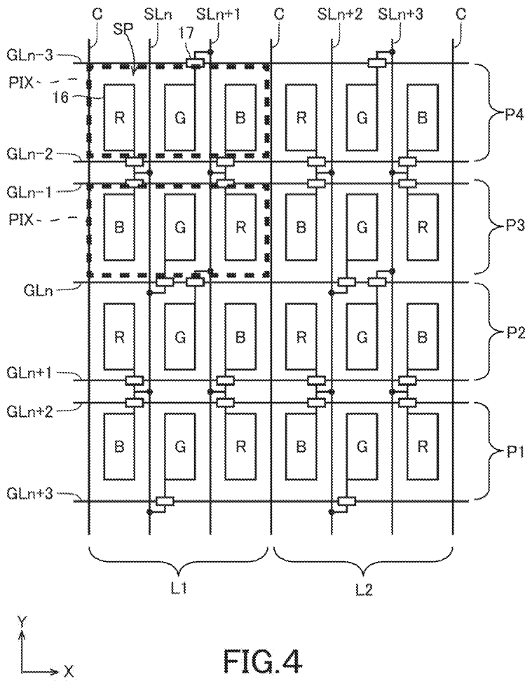

Next, the following description describes a more specific configuration of the display area 10R in the present embodiment, while referring to FIG. 4. FIG. 4 schematically shows a part of the display area 10R.

As shown in FIG. 4, in the display area 10R, the pixel electrodes 16 are arranged in matrix. An area SP where one pixel electrode 16 is provided constitutes one subpixel, and in this drawing, the subpixels in four pixel rows P1 to P4 are partially shown as an example.

Further, though the illustration is omitted in this drawing, common electrodes are provided on the active matrix substrate 10. The common electrodes are provided so as to be opposed to the pixel electrodes 16 of the pixels, with an insulating film being interposed between. The common electrode is formed with, for example, a transparent conductive film made of ITO or the like, and a predetermined voltage is applied thereto.

In FIG. 4, the characters of “R”, “G”, and “B” denoting the respective pixel electrodes 16 indicate the colors of the color filters. The subpixels corresponding to the color of R are referred to as pixels R, the subpixels corresponding to the color of G are referred to as pixels G, and the subpixels corresponding to the color of B are referred to as pixels B. One pixel (picture element) PIX is composed of subpixels of three colors.

In the present embodiment, the subpixels in one pixel PIX in an odd-numbered row are arranged in the order of the pixel R, the pixel G, and the pixel B in the gate line GL extending direction, and the subpixels in one pixel PIX in an even-numbered row are arranged in the order of the pixel B, the pixel G, and the pixel R in the gate line GL extending direction. Thereby, a column including only the pixels G is arrayed every three columns, and each of the columns other than the columns where the pixels G are arrayed includes both of the pixels R and the pixels B. As a result, the pixels G in two pixels (picture elements) PIX adjacent in the Y-axis direction are located at the same position in the X-axis direction, while the pixels R and the pixels B in the foregoing two pixels (picture elements) PIX are located at inverted positions in the X-axis direction.

Besides, in the present embodiment, the source lines SL are arranged in such a manner that two of the source lines SL are provided with respect to three columns of the subpixels, i.e., with respect to one of the pixels (picture elements) PIX. More specifically, as shown in FIG. 4, the two source lines SLn and SLn+1 are provided with respect to the pixel column L1 including three columns of subpixels, and the two source lines Sln+2 and Sln+3 are provided with respect to the pixel column L2 including three columns of subpixels. Further, one common electrode line C is provided with respect to each of the pixel columns L1 and L2. The common electrode lines C are connected with common electrodes (not shown). By providing the common electrode lines C, the distribution of resistance of the common electrodes (not shown) is reduced, whereby the display quality is improved.

The pixel electrode 16 is connected with a switching element 17, and is connected with one gate line GL and one source line SL via the switching element 17. The switching element 17 is formed with, for example, a thin film transistor. The switching element 17 has a gate connected with the gate line GL, a source connected with the source line SL, and a drain connected with the pixel electrode 16.

In this example, the gate lines GLn−1, GLn, and GLn+1 are provided with respect to the pixel rows P2, P3 among the pixel rows P1 to P4. The pixel electrode 16 of the pixel G in the pixel row P2 is connected with the gate line GLn via the switching element 17. Each of the pixel electrodes 16 of the pixels R and B in the pixel row P2 is connected with the gate line GLn+1 via the switching element 17. Further, the pixel electrode 16 of the pixel G in the pixel row P3 is connected with the gate line GLn via the switching element 17. Each of the pixel electrodes 16 of the pixels R and B in the pixel row P3 is connected with the gate line GLn−1 via the switching element 17.

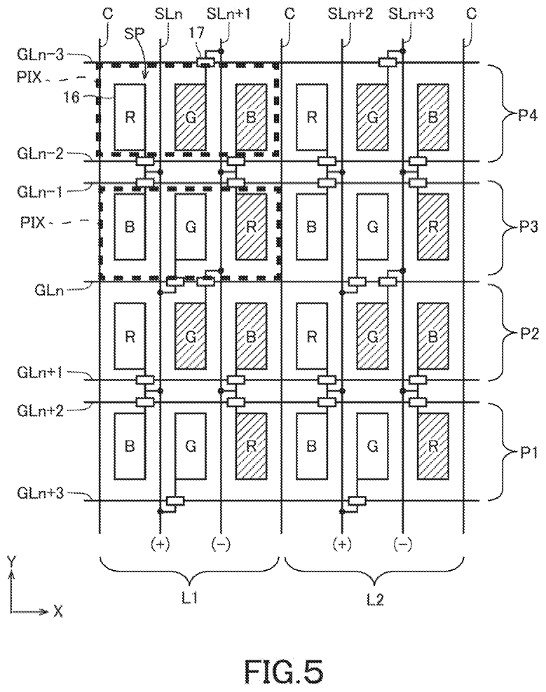

FIG. 5 schematically shows exemplary polarities of data voltage signals input to the source lines SL shown in FIG. 4, and exemplary polarities of respective voltages of the pixels, in a certain frame. Further, in the present embodiment, data voltages of polarities opposite to each other are applied to two source lines SL of each of the pixel columns L1 and L2, respectively.

In other words, in this example, as shown in FIG. 5, positive-polarity (+) data voltage signals are input to the source lines SLn and SLn+2, and negative-polarity (−) data voltage signals are input to the source lines SLn+1 and SLn+3, in a certain frame.

As a result, in FIG. 5, negative-polarity data voltages are applied to the subpixels including the pixel electrodes 16 indicated by hatching with lines rising to the right, and positive-polarity data voltages are applied to the subpixels including the pixel electrodes 16 that are not hatched. Therefore, in each case of the pixels R, G, and B, both of the subpixels to which positive-polarity data voltages are applied, and the subpixels to which negative-polarity data voltages are applied, are included.

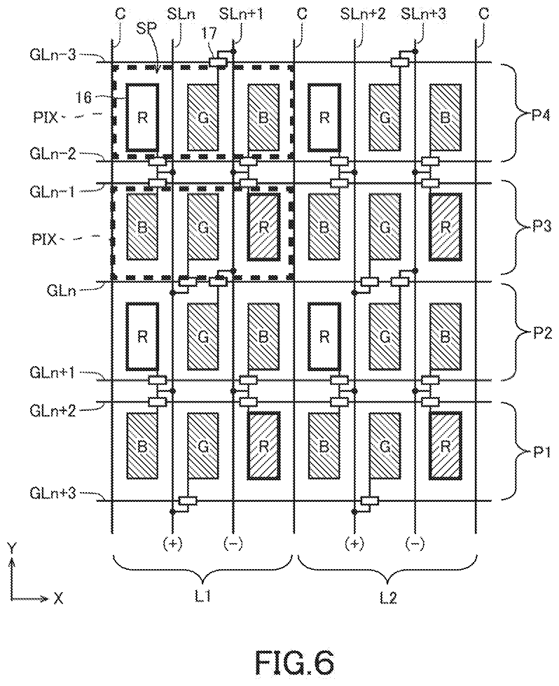

Here, polarities of pixel voltages in a case where only red color is displayed in the configuration shown in FIG. 5 are shown in FIG. 6. In FIG. 6, the pixels G and B are assumed to display black. For example, in a case where the display panel 2 is of the normally black type, black is displayed by not applying a voltage to the pixels G and B. In this drawing, to distinguish the pixels G and B from the pixels R, the pixel electrodes 16 in the pixels G and B are hatched with lines rising to the left.

Here, positive-polarity data voltages are applied to the pixels R in the pixel rows P2 and P4, and negative-polarity data voltages are applied to the pixels R in the pixel rows P1 and P3. In other words, the pixels R include both of the subpixels to which positive-polarity data voltages are applied, and the subpixels to which negative-polarity data voltages are applied. Therefore, even if the polarities of the data voltages applied to the source lines SL are inverted at every frame, the polarities of the pixel voltages of the pixels R are not biased to either one of the polarities, which makes it unlikely that flicker would occur.

Incidentally, the above-described example is described as an exemplary case where only red color is displayed on the display panel 2; the foregoing description applies to a case where only green color or only blue color is displayed. In other words, in the configuration shown in FIG. 5, the pixels B include both of the subpixels to which positive-polarity data voltages are applied, and the subpixels to which negative-polarity data voltages are applied. Further, the pixels G also include both of the subpixels to which positive-polarity data voltages are applied, and the subpixels to which negative-polarity data voltages are applied. Therefore, even if black color is displayed in the pixels R, as well as the pixels G or B, and the polarities of the data voltage signals input to the source lines SL are inverted at every frame, the voltage polarities of the pixels G or B are not biased to either one of the polarities, which makes it unlikely that flicker would occur.

### Embodiment 2

The present embodiment is described with reference to an exemplary case where the arrangement of the pixels R. G, and B is different from that in Embodiment 1 described above.

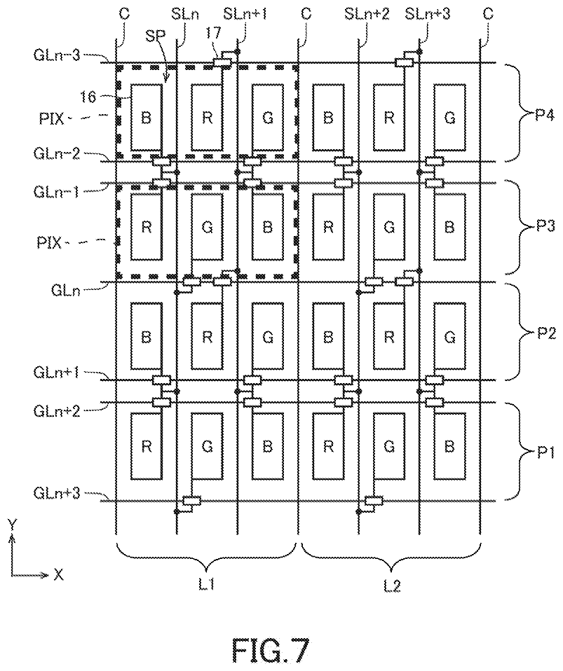

FIG. 7 schematically shows an exemplary arrangement of subpixels in the present embodiment. As shown in FIG. 7, in the pixel rows P2 and P4, the subpixels in one pixel PIX (indicated by the broken line frame) are arrayed in the order of the pixel B, the pixel R, and the pixel G in the X axis positive direction. On the other hand, in the pixel rows P1 and P3, the subpixels in one pixel PIX (broken line frame) are arrayed in the order of the pixel R, the pixel G. and the pixel B in the X axis positive direction. As a result, the pixels R, the pixels G, and the pixels B in the pixels (picture elements) PIX adjacent in the Y-axis direction are located at different positions in the X-axis direction.

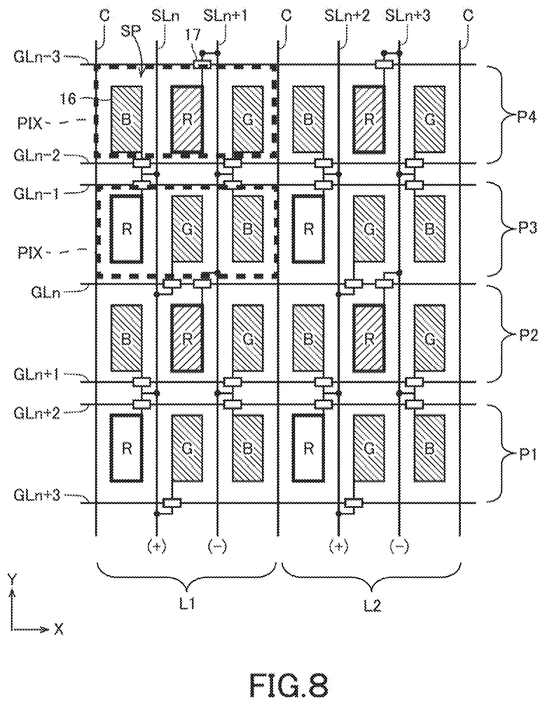

In this configuration, for example, positive-polarity data voltage signals are applied to the source lines SLn and SLn+2, and negative-polarity data voltage signals are applied to the source lines SLn+1 and SLn+3. Then, only red color is displayed, while the pixels G and the pixels B are caused to display black. Here, polarities of pixel voltages in a case where such display is carried out are shown in FIG. 8. Incidentally, the hatching lines applied to the pixel electrodes 16 and the like in FIG. 8 are similar to those used in Embodiment 1. In other words, hatching with lines rising to the right indicates pixel electrodes to which negative-polarity pixel voltages are applied, and non-hatching indicates pixel electrodes to which positive-polarity pixel voltages are applied. Further, hatching with lines rising to the left indicates black display.

As shown in FIG. 8, among the pixels R in which the pixel electrodes 16 are indicated by thick-line frames, the pixels R in the pixel rows P4 and P2 have negative-polarity pixel voltages, and the pixels R in the pixel rows P1 and P3 have positive-polarity pixel voltages. The pixels R therefore include both of the subpixels to which positive-polarity data voltages are applied, and the subpixels to which negative-polarity data voltages are applied.

In the present embodiment, accordingly, even if the polarities of the data voltages applied to the source lines SL are inverted at every frame, the polarities of the pixel voltages of the pixels R are not biased to either one of the polarities, which makes it unlikely that flicker would occur.

Incidentally, in this example, even in a case where only green color or blue color is displayed; the same effect as that in the case where only red color is displayed can be achieved as well. Further, as shown in FIG. 8, regarding the pixels G as well as regarding the pixels B, the pixels also include both of the subpixels to which positive-polarity data voltages are applied, and the subpixels to which negative-polarity data voltages are applied. Therefore, even if the polarities of the data voltages applied to the source lines SL are inverted at every frame, the polarities of the pixel voltages of the pixels G or the pixels B are not biased to either one of the polarities, which makes it unlikely that flicker would occur.

### Embodiment 3

The present embodiment is described with reference to an exemplary case where the array of the pixels R, G, and B is different from that in Embodiments 1 and 2 described above.

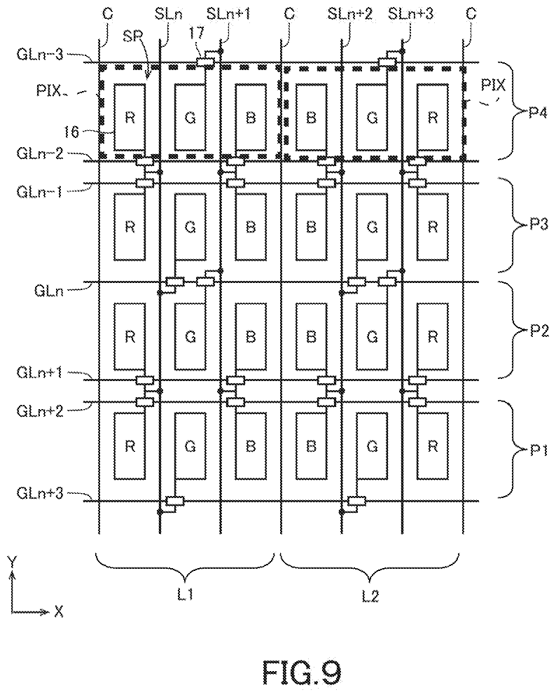

FIG. 9 schematically shows an exemplary arrangement of subpixels in the present embodiment. As shown in FIG. 9, in the present embodiment, in each pixel row, the pixels PIX (indicated by the broken line frame) in each of which the subpixels are arrayed in the order of the pixel R, the pixel G, and the pixel B in the X axis positive direction, and the pixels PIX (indicated by the broken line frame) in each of which the subpixels are arrayed in the order of the pixel B, the pixel G, and the pixel R in the same direction, are arranged alternately. In other words, in this example, in each pixel row, the subpixels of three colors included in one pixel (picture element) PIX are located at positions resulting from inversion of the positions of the subpixels included in another pixel (picture element) adjacent thereto in the X-axis direction. In each column, the subpixels of the same color are arrayed.

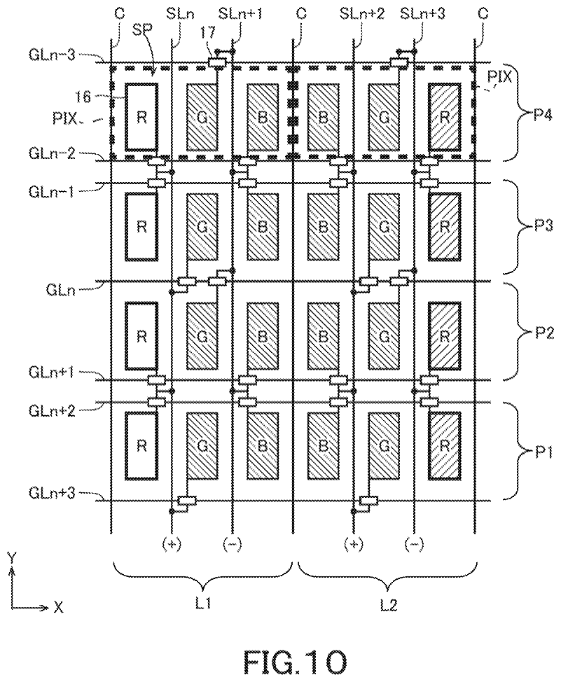

In this configuration, for example, positive-polarity data voltage signals are applied to the source lines SLn and SLn+2, and negative-polarity data voltage signals are applied to the source lines SLn+1 and SLn+3. Then, only red color is displayed, while the pixels G and the pixels B are caused to display black. Here, polarities of pixel voltages in a case where such display is carried out are shown in FIG. 10. Incidentally, in FIG. 10, the hatching lines applied to the pixel electrodes 16 and the like are identical to those used in Embodiment 1. In other words, hatching with lines rising to the right indicates pixel electrodes to which negative-polarity pixel voltages are applied, and non-hatching indicates pixel electrodes to which positive-polarity pixel voltages are applied. Further, hatching with lines rising to the left indicates black display.

As shown in FIG. 10, among the pixels R indicated by thick-line frames, the pixels R in the pixel column L2 have negative-polarity pixel voltages, and the pixels R in the pixel column L1 have positive-polarity pixel voltages. In other words, pixel voltages having polarities opposite to each other are applied to the pixels R in the pixels (picture elements) adjacent to each other, respectively.

In the present embodiment, therefore, even if the polarities of the data voltages applied to the source lines SL are inverted at every frame, the polarities of the pixel voltages of the pixels R are not biased to either one of the polarities, which makes it unlikely that flicker would occur.

Incidentally, in this example, even in a case where only green color or blue color is displayed; the same effect as that in the case where only red color is displayed can be achieved as well. As shown in FIG. 10, pixel voltages having polarities opposite to each other are applied to the pixels G or the pixels B in the pixels (picture elements) adjacent to each other, respectively. Therefore, even if the polarities of the data voltages applied to the source lines SL are inverted at every frame, the polarities of the pixel voltages of the pixels G or the pixels B are not biased to either one of the polarities, which makes it unlikely that flicker would occur.

### Modification Example

The embodiments of the present invention, which are described above, are not limited to the above-described specific examples; the embodiment may vary in many ways.

(1) The embodiments described above are described with reference to an exemplary configuration in which one pixel (picture element) is composed of subpixels of three colors, i.e., R, G, and B, but the pixel may be composed of subpixels of four colors such as R, G, B, and Y (yellow).

(2) Further, the embodiments described above are described with reference to an exemplary configuration in which the gate drivers 11 are provided outside the display area 10R. The configuration however may be such that all or a part of the elements that compose the gate drivers 11 are provided in the display area 10R.

1. A liquid crystal display device, comprising: an active matrix substrate; a counter substrate that is arranged so as to be opposed to the active matrix substrate; and a liquid crystal layer interposed between the active matrix substrate and the counter substrate,
wherein the active matrix substrate includes:
a plurality of subpixels arranged in matrix;
a plurality of source lines to each of which a data voltage having either a positive polarity or a negative polarity with respect to a predetermined potential as a reference is applied; and
a plurality of gate lines connected with the subpixels,
the counter substrate includes color filters that have a plurality of different colors,
each of the subpixels corresponds to any one of the colors, and each pixel is composed of the subpixels of the plurality of colors, and
each of the subpixels included in the each pixel is connected to the source line to which a data voltage having a polarity opposite to a polarity of a data voltage applied to the subpixel included in another pixel adjacent to the said pixel in a gate line extending direction or a source line extending direction is applied, the subpixel included in the another pixel being of the same color as the color of the said subpixel.

2. The liquid crystal display device according to claim 1,
wherein, in the pixels adjacent in the source line extending direction, among the subpixels of the plurality of colors, the subpixels of one of the colors are located at the same positions in the gate line extending direction, and the subpixels of each of the other colors are located at positions different from each other in the gate line extending direction.

3. The liquid crystal display device according to claim 1,
wherein, in the pixels adjacent in the source line extending direction, the subpixels of the plurality of colors are arranged in such a manner that the subpixels of the same color are located at different positions in the gate line extending direction.

4. The liquid crystal display device according to claim 1,
wherein the plurality of colors include at least three colors that are different from one another, and
position relationship of the subpixels of the colors other than one color, among the subpixels of the plurality of colors in one of the pixels, is different from position relationship of the subpixels of the colors other than the one color, in another one of the pixels that is adjacent to the said pixel in the gate line extending direction.

5. The liquid crystal display device according to claim 1,
wherein the plurality of colors include three colors that are different from one another, and
the source lines are arranged in such a manner that two of the source lines to which data voltages having polarities opposite to each other are applied, respectively, are provided with respect to every three columns of the subpixels,
the polarities of the data voltages applied to the source lines are inverted at every frame, and
the gate lines are arranged approximately in parallel in such a manner that three of the gate lines are provided with respect to two rows of the subpixels.

6. The liquid crystal display device according to claim 1,
wherein the active matrix substrate further includes:
a common electrode; and
a plurality of common electrode lines that are provided approximately in parallel with the source lines and are connected with the common electrode.
